(19) United States
(12) Patent Application Publication
(10) Pub. No.: US 2023/0178913 A1
(43) Pub. Date: Jun. 8, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Pengfei LANG, Mie (JP); Daisuke SAITO, Mie (JP)

(21) Appl. No.: 17/911,867

(22) PCT Filed: Mar. 5, 2021
(86) PCT No.: PCT/JP2021/008657

§ 371 Date: Sep. 15, 2022

(30) Foreign Application Priority Data
Mar. 26, 2020 (JP) 2020-055508

(51) Int. Cl. H01R 12/72; H01R 13/516; H01R 13/42

(52) U.S. Cl. CPC H01R 12/72; H01R 13/516; H01R 13/42

(57) ABSTRACT

A connector is provided with an inner housing to be arranged inside an outer housing, a retainer mounting hole open in one surface of the inner housing, a terminal fitting to be accommodated into the inner housing, and a retainer to be inserted into the retainer mounting hole and having a part configured to lock the terminal fitting in a properly inserted state and project outward from the one surface of the inner housing in a half-inserted state. The outer housing includes an interfering portion capable of interfering with the retainer in the half-inserted state. The inner housing is held displaceably to a first posture where the one surface is located away from the interfering portion and a second posture where the one surface is located closer to the interfering portion than in the first posture with respect to the outer housing.

### TECHNICAL FIELD

The present disclosure relates to a connector.

### BACKGROUND

A connector described in Patent Document 1 is provided with a terminal fitting, a housing for accommodating the terminal fitting, an opening formed in the outer peripheral surface of the housing and a retainer to be inserted into the opening. The retainer is movable to an opening position for opening the opening and a closing position for closing the opening. The retainer locks the terminal fitting at the closing position. The retainer is arranged to project to the outside of the housing when being at the opening position or a midway position between the opening position and the closing position.

The housing is fit into a mating receptacle. When the retainer is at the opening position or midway position, an edge part of the receptacle interferes with the retainer. In this way, a fitting operation of the housing and the receptacle is restricted and it can be known that the retainer is in an incompletely inserted state (hereinafter, referred to as a half-inserted state) without reaching the closing position.

### PRIOR ART DOCUMENT

### Patent Document

Patent Document 1: JP 2016-225075 A

### SUMMARY OF THE INVENTION

### Problems to be Solved

In the above case, the half-inserted state of the retainer can be known at a site where the housing and the receptacle are fit. However, it may be required before the transportation of the connector to the site of the fitting operation in some cases to guarantee that the retainer is properly inserted.

Accordingly, the present disclosure aims to provide a connector capable of detecting whether or not a retainer is properly inserted before connector connection.

### Means to Solve the Problem

The present disclosure is directed to a connector with an outer housing, an inner housing to be arranged inside the outer housing, a retainer mounting hole open in one surface of the inner housing, a terminal fitting to be accommodated into the inner housing, and a retainer to be inserted into the retainer mounting hole, the retainer having a part configured to lock the terminal fitting in a properly inserted state and project outward from the one surface of the inner housing in a half-inserted state, wherein the outer housing includes an interfering portion capable of interfering with the retainer in the half-inserted state, and the inner housing is held displaceably to a first posture where the one surface is located away from the interfering portion and a second posture where the one surface is located closer to the interfering portion than in the first posture with respect to the outer housing.

### Effect of the Invention

According to the present disclosure, it is possible to provide a connector capable of detecting whether or not a retainer is properly inserted before connector connection.

### BRIEF DESCRIPTION OF THE DRAWINGS

FIG. 1 is a perspective view of a connector according to one embodiment showing a state where inner housings are held in a second posture with respect to an outer housing.

FIG. 2 is a perspective view showing a state where the inner housings are held in a first posture with respect to the outer housing.

FIG. 3 is a side view in section showing a state where retainers are held at a full locking position with respect to the inner housings and the inner housings are held in the second posture with respect to the outer housing.

FIG. 4 is a side view in section showing a state where the retainers are left in a half-inserted state with respect to the inner housings to restrict the inner housings from reaching the second posture with respect to the outer housing.

FIG. 5 is a side view in section showing a state where the connector is connected to a mating connector and terminal fittings are connected to a circuit board.

FIG. 6 is a perspective view of the outer housing.

FIG. 7 is a perspective view of a guide member.

FIG. 8 is a perspective view of a pair of upper and lower inner housings.

FIG. 9 is a view of the inner housing viewed from a connection surface side.

FIG. 10 is a perspective view of a pair of upper and lower retainers.

FIG. 11 is an enlarged section showing a state where the retainer is held at a partial locking position with respect to the inner housing.

FIG. 12 is an enlarged section showing a state where a locking portion of the outer housing is locked to a standby lock receiving portion of the guide member.

### DETAILED DESCRIPTION TO EXECUTE THE INVENTION

### Description of Embodiments of Present Disclosure

First, embodiments of the present disclosure are listed and described.

(1) The connector of the present disclosure is provided with an outer housing, an inner housing to be arranged inside the outer housing, a retainer mounting hole open in one surface of the inner housing, a terminal fitting to be accommodated into the inner housing, and a retainer to be inserted into the retainer mounting hole, the retainer having a part configured to lock the terminal fitting in a properly inserted state and project outward from the one surface of the inner housing in a half-inserted state, wherein the outer housing includes an interfering portion capable of interfering with the retainer in the half-inserted state, and the inner housing is held displaceably to a first posture where the one surface is located away from the interfering portion and a second posture where the one surface is located closer to the interfering portion than in the first posture with respect to the outer housing.

According to the above configuration, the one surface approaches the interfering portion and the retainer in the half-inserted state can interfere with the interfering portion in the process of displacing the inner housing from the first posture to the second posture. Thus, the inner housing is restricted from reaching the second posture and it can be detected that the retainer is in the half-inserted state. Therefore, it can be detected that the retainer is in the half-inserted state before shipment to a site where a connecting operation to a mating connector is performed.

(2) Preferably, the terminal fitting is connected to a circuit board, the inner housing has a connection surface and a connection port for connection of the terminal fitting and the circuit board is open in the connection surface, and the connection surface is arranged to face away from a surface of the circuit board in the second posture and arranged closer to the surface of the circuit board in the first posture than in the second posture with the circuit board accommodated in the outer housing.

According to the above configuration, the contact of the terminal fitting with a corner part of an end surface of the circuit board can be avoided and a state where the terminal fitting and the circuit board are satisfactorily connected can be realized. In this case, since an operation of detecting the half-inserted state of the retainer is linked to an operation of connecting the terminal fitting to the surface of the circuit board, it is not necessary to individually perform each operation and a workload can be reduced.

(3) The connection surface may be arranged obliquely with respect to a plate surface of the circuit board in the second posture and arranged along the surface of the circuit board in the first posture, and the inner housing may be in an inclined posture corresponding to the connection surface with respect to the outer housing and the one surface on a side opposite to the connection surface may be located on an outer side of inclination in the second posture.

According to the above configuration, the retainer in the half-inserted state can interfere with the interfering portion in the process of displacing the inner housing to the inclined posture. Thus, the interfering portion needs not have a special shape such as the one projecting toward the one surface of the inner housing, and the interfering portion can be easily formed.

### Details of Embodiments of Present Disclosure

### First Embodiment

A specific example of the present disclosure is described below with reference to the drawings. Note that the present invention is not limited to this illustration and is intended to be represented by claims and include all changes in the scope of claims and in the meaning and scope of equivalents.

### Embodiment

A connector 10 according to one embodiment includes inner housings 20, an outer housing 21, terminal fittings 60 and retainers 80. The outer housing 21 is connectable to a mating connector 100. Note that, in the following description, surface sides facing each other when the connection of the connector 10 and the mating connector 100 (hereinafter, referred to as the both connectors 10, 100) is started are referred to as front sides.

(Mating Connector)

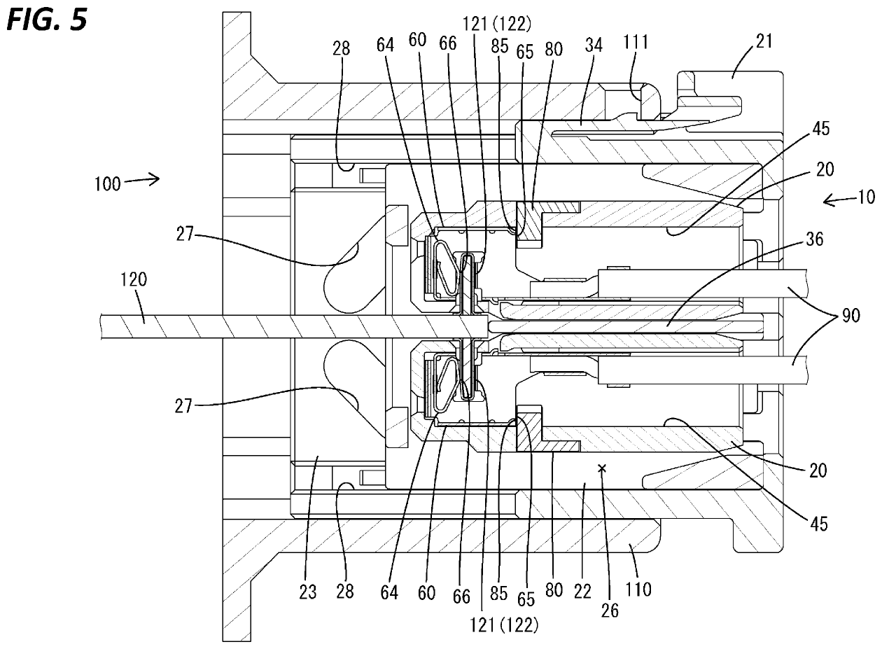

As shown in FIG. 5, the mating connector 100 includes a receptacle 110 and a circuit board 120. The circuit board 120 is made of LCP (Liquid Crystal Polymer) resin or the like as a base material except electrically conductive portions 121. Glass fiber and other additives may be added to the LCP resin as the base material in the material constituting the circuit board 120.

The receptacle 110 is made of synthetic resin. A hole-like lock receiver 111 is provided to penetrate through a front end side of an upper wall part of the receptacle 110. The receptacle 110 and the circuit board 120 are mounted on an unillustrated case. The receptacle 110 and the circuit board 120 are kept at fixed relative positions via the case. The circuit board 120 is arranged in the receptacle 110.

The electrically conductive portion 121 includes a connecting member 122 formed by bending a metal plate material. The connecting member 122 is fit to a projection part projecting on a plate surface (surface) of the circuit board 120 and formed by molding. The connecting member 122 is connected to an unillustrated conductive path of the circuit board 120. A plurality of the connecting members 122 are arranged to stand side by side in a lateral direction on the plate surface of the circuit board 120.

(Schematic Configuration of Overall Connector)

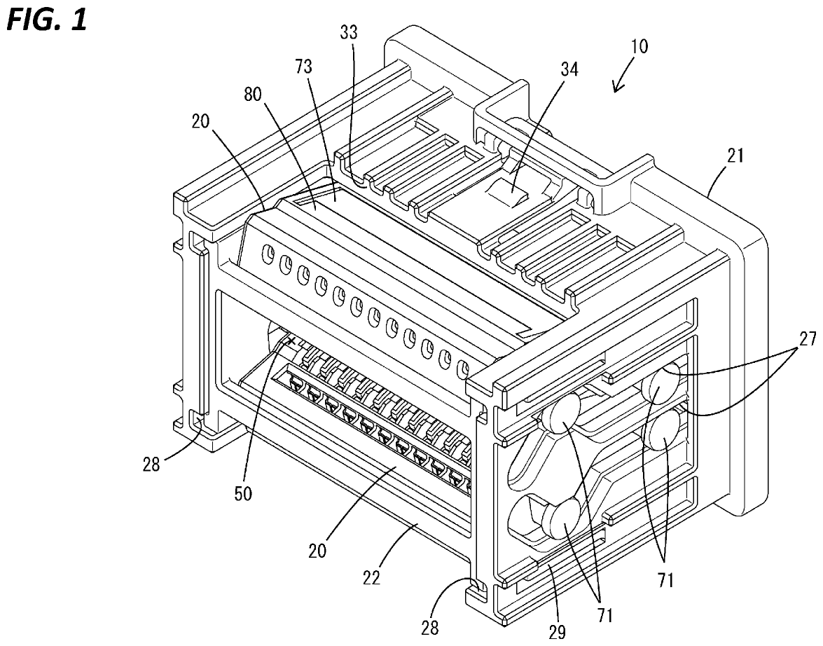

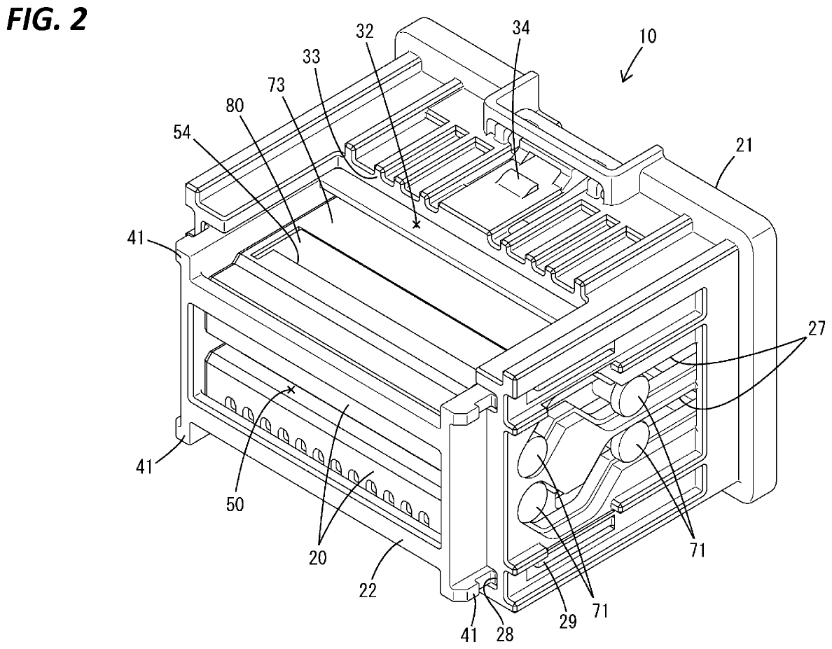

As shown in FIGS. 1 and 2, the inner housings 20 are arranged inside the outer housing 21. A pair of the inner housings 20 are provided in a vertical direction (vertical direction of FIG. 1). The inner housing 20 is assembled displaceably to a first posture (state shown in FIG. 2) and a second posture (first state) with respect to the outer housing 21. The first posture is a posture in which the inner housing 20 is horizontally arranged along a front-rear direction. The second posture is a posture in which the inner housing 20 is obliquely arranged in a direction intersecting the front-rear direction. A guide member 22 for ensuring the stability of displacements of the inner housings 20 is provided between the outer housing 21 and the inner housings 20.

The retainer 80 is mounted into the inner housing 20. A pair of the retainers 80 are provided in the vertical direction to correspond to the inner housings 20. A plurality of the terminal fittings 60 are accommodated in the inner housing 20. The retainer 80 locks the terminal fittings 60 and restricts the terminal fittings 60 from coming out from the inner housing 20.

As shown in FIG. 5, the terminal fittings 60 are electrically connected to the electrically conductive portions 121 of the circuit board 120. When the inner housing 20 is displaced from the second posture to the first posture, the terminal fittings 60 are displaced from positions facing the plate surface of the circuit board 120 toward the conductive portions 121.

(Outer Housing)

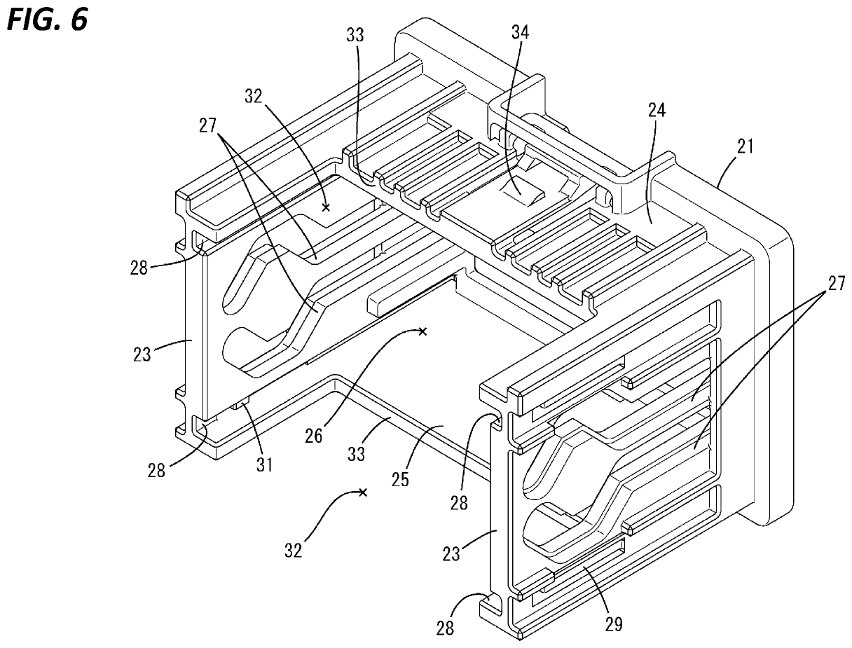

The outer housing 21 is made of synthetic resin and has a box shape open forward and rearward as a whole as shown in FIG. 6. The outer housing 21 is made of the same material (material containing an LCP resin as a base material as described later) as the inner housings 20. However, in view of cost and the like, the outer housing 21 can also be made of the same material (material containing a PBT (Polybutylene Terephthalate) resin as a base material) as the retainer 80 or a material different from those of the retainer 80 and the inner housings 20.

This outer housing 21 includes a pair of side walls 23 laterally facing each other, an upper wall 24 extending between the upper ends of the both side walls 23 and a lower wall 25 extending between the lower ends of the both side walls 23. A housing accommodation space 26 is provided inside the outer housing 21.

Each of the both side walls 23 is provided with a pair of upper and lower guide grooves 27 for guiding displacements of the inner housings 20. The guide groove 27 penetrates through the corresponding side wall 23 in a wall thickness direction and communicates with the housing accommodation space 26 on an inner side. The guide grooves 27 include straight regions arranged along the front-rear direction in a rear part, separating regions inclined to be vertically separated toward the front from the straight regions, short top regions arranged to extend forward along the front-rear direction from the separating regions and proximate regions inclined to approach a vertically central part of the side wall 23 toward the front from the top regions. The straight regions are open in the rear end of the outer housing 21.

A pair of upper and lower insertion grooves 28 are provided in both upper and lower end parts of the inner surface of each of the both side walls 23. The insertion groove 28 is a bottomed groove closed on the outer surface of the side wall 23, extends in the front-rear direction and is open in the front end of the side wall 23. Resilient locking portions 29 are provided in both upper and lower end parts of the both side walls 23 by cutting the bottom surfaces of the insertion grooves 28. The resilient locking portion 29 is deflectable and deformable inward and outward (leftward and rightward) with a rear end part as a fulcrum. As shown in FIG. 12, a locking projection 31 projecting inward is provided on a front end part (tip part) of the resilient locking portion 29. A later-described inserting portion 41 of the guide member 22 is inserted into the insertion groove 28. The resilient locking portion 29 locks later-described lock receiving portions 42, 43 and 44 of the guide member 22.

As shown in FIG. 6, the upper wall 24 and the lower wall 25 are provided in a rear part of the outer housing 21. The upper and lower surfaces of the outer housing 21 have openings 32 in front of the upper and lower walls 24, 25. The openings 32 communicate with the housing accommodation space 26 on inner sides. Both left and right ends of the openings 32 are defined by the both side walls 23. The openings 32 are open forward. Rear parts of the openings 32 are defined by the front ends of the upper and lower walls 24, 25. The front ends of the upper and lower walls 24, 25 are edge parts linearly arranged along a width direction (lateral direction) and constituted as interfering portions 33 capable of interfering with the retainers 80 in a half-inserted state to be described later. The inner housing 20 in an inclined posture to be described later is allowed to enter and escape into the opening 32. The upper wall 24 is provided with a deflectable and deformable lock arm 34. The front end of the lock arm 34 serving as a deflection fulcrum constitutes a laterally central part of the interfering portion 33.

(Guide Member)

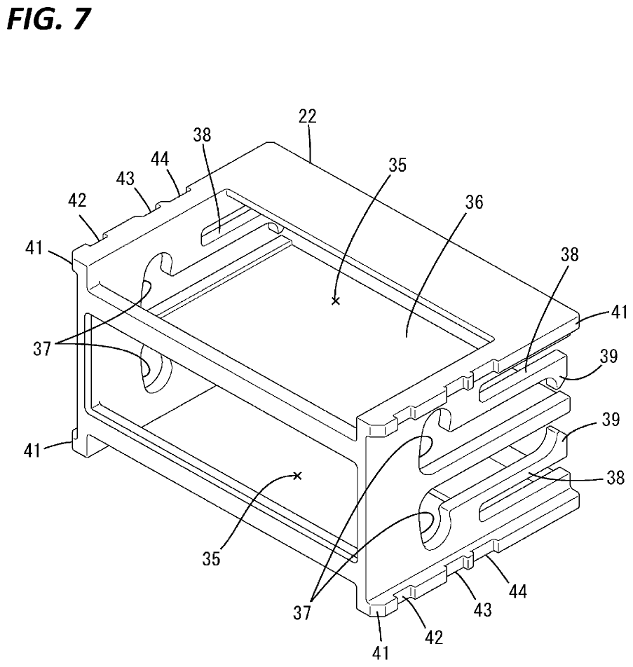

The guide member 22 is made of synthetic resin and has a box shape open forward and rearward as a whole as shown in FIG. 7. The guide member 22 is arranged inside the outer housing 21 and outside the inner housings 20. The guide member 22 is displaceable in synchronism with the inner housings 20 with respect to the outer housing 21.

The upper and lower surfaces of the guide member 22 have window portions 35, which are rectangular openings in a plan view and a bottom view. The peripheries of the window portions 35 are defined by rectangular frame parts in the upper and lower surfaces of the guide member 22. The periphery of the front surface of the guide member 22 is also defined by a rectangular frame part including left and right side wall parts. The window portions 35 communicate with the openings 32 with the guide member 22 arranged inside the outer housing 21. The inner housings 20 in the inclined posture are allowed to enter and escape into the window portions 35.

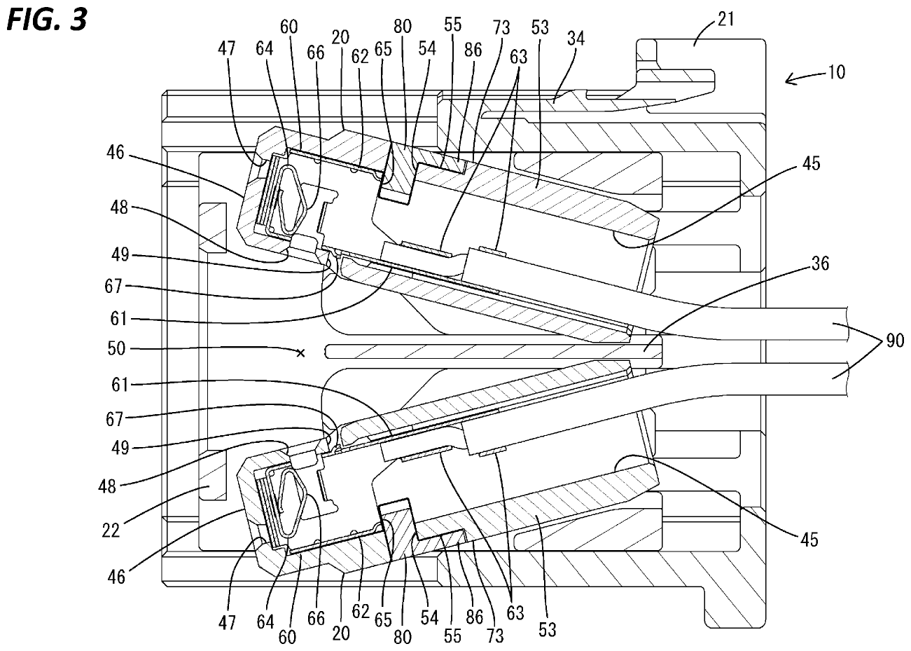

The guide member 22 includes a partition wall 36 extending between vertically central parts of the left and right side wall parts. As shown in FIG. 3, the partition wall 36 is in the form of a horizontal plate along the front-rear direction. With the guide member 22 arranged inside the outer housing 21, the housing accommodation space 26 is divided into upper and lower parts by the partition wall 36. The tip (front end) of the partition wall 36 is linearly arranged along the width direction behind the front ends of the side wall parts.

A pair of upper and lower guiding grooves 37 for receiving later-described guide pins 71 of the inner housings 20 are provided in each of the left and right side wall parts of the guide member 22. The guiding grooves 37 have straight regions extending in the front-rear direction and open in the rear end of the side wall part and separating regions extending in directions away from each other from the front ends of the straight regions. Front and rear guide pins 71 are inserted into both end sides of the straight region of the guiding groove 37. The front guide pins 71 are displaceably arranged in the separating regions of the guiding grooves 37 when the inner housing 20 is in the inclined posture with respect to the outer housing 21.

The left and right side wall parts of the guide member 22 are provided with resilient arm portions 38 defining straight parts of the guiding grooves 37. A claw-like holding projection 39 projecting inward in a rear part of the guiding groove 37 is provided on a rear end part of the resilient arm portion 38. The resilient arm portion 38 is deflectable and deformable with a front end part as a fulcrum.

A pair of upper and lower inserting portions 41 continuous with the upper and lower surfaces and protruding laterally are provided on each of the left and right side wall parts of the guide member 22. The inserting portion 41 is in the form of a rib extending in the front-rear direction. The inserting portion 41 is provided with the standby lock receiving portion 42, the assembling lock receiving portion 43 and the restricting lock receiving portion 44. These lock receiving portions 42, 43 and 44 are provided at intervals in the front-rear direction by recessing the side surface (lateral end surface) of the inserting portion 41. Specifically, the standby lock receiving portion 42, the assembling lock receiving portion 43 and the restricting lock receiving portion 44 are successively provided side by side from front in the side surface of the inserting portion 41.

The guide member 22 can be assembled with the outer housing 21 from front and reach an assembled position by way of a movement restricting position. Further, the guide member 22 can be moved relatively forward with respect to the outer housing 21 and reach a standby position. The restricting lock receiving portion 44, the assembling lock receiving portion 43 and the standby lock receiving portion 42 receive the locking projection 31 of the resilient locking portion 29 respectively at the movement restricting position, the assembled position and the standby position.

(Terminal Fittings)

The terminal fitting 60 is integrally formed, such as by bending an electrically conductive metal plate. As shown in FIG. 3, the terminal fitting 60 includes a base portion 61 extending in the front-rear direction, a box-shaped terminal body 62 provided in a front part of the base portion 61 and a barrel portion 63 in the form of an open barrel provided in a rear part of the base portion 61. The barrel portion 63 is crimped and connected to an end part of a wire 90. A deflectable and deformable resilient contact piece 64 is arranged in the terminal body 62. The resilient contact piece 64 is folded after rising from the front end of the base portion 61, and shaped to be long in the vertical direction as a whole. The terminal body 62 is also shaped to be long in the vertical direction to correspond to the resilient contact piece 64. A retained portion 65 along the vertical direction is provided on the rear end edge of the terminal body 62. The retained portion 65 is formed to be long in the vertical direction due to a height difference between the terminal body 62 and the barrel portion 63. The retained portion 65 is locked by a later-described retaining portion 85 of the retainer 80. The base portion 61 of the terminal fitting 60 is provided with a hole open to allow the entrance of the connecting member 122 of the circuit board 120. The resilient contact piece 64 includes a contact point portion 66 at a position facing the hole of the base portion 61.

(Inner Housing)

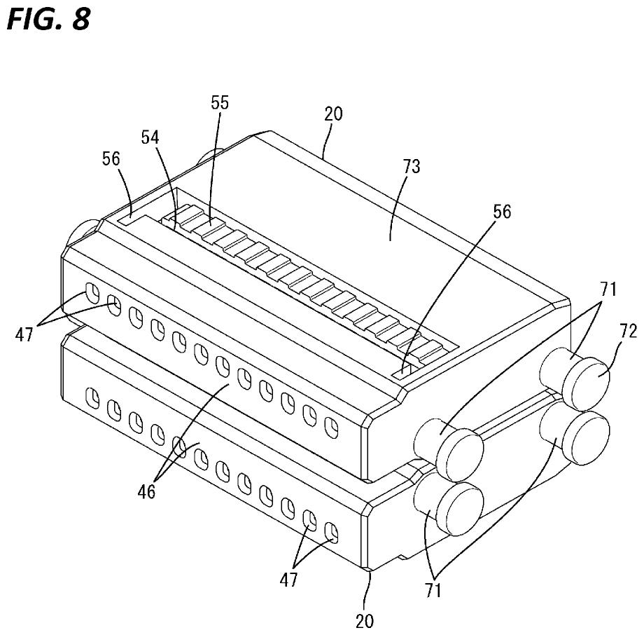

The inner housing 20 is made of synthetic resin and, as shown in FIG. 8, has a flat shape extending in the width direction as a whole. The material of the inner housings 20 is the same as that of the circuit board 120 and contains the LCP resin as the base material. However, the inner housings 20 may be made of a material different from that of the circuit board 120 and may be preferably made of a material having a thermal expansion coefficient (linear expansion coefficient) approximate to that of the material constituting the circuit board 120. Glass fiber and other additives may be added to the LCP resin as the base material in the material constituting the inner housings 20.

As shown in FIG. 3, the inner housing 20 is provided with a plurality of cavities 45 (only one is shown in FIG. 3). The respective cavities 45 are arranged in a row in the width direction. The cavity 45 has a vertically long rectangular cross-sectional shape, extends in the front-rear direction and is open in the rear end of the inner housing 20. The terminal fitting 60 is inserted into each cavity 45 from behind.

As shown in FIG. 8, inspection windows 47 for a continuity inspection of the terminal fitting 60 are provided in the front wall 46 of the inner housing 20 for each cavity 45. The front surface of each cavity 45 is closed by the front wall 46 of the inner housing 20 except at the inspection window 47.

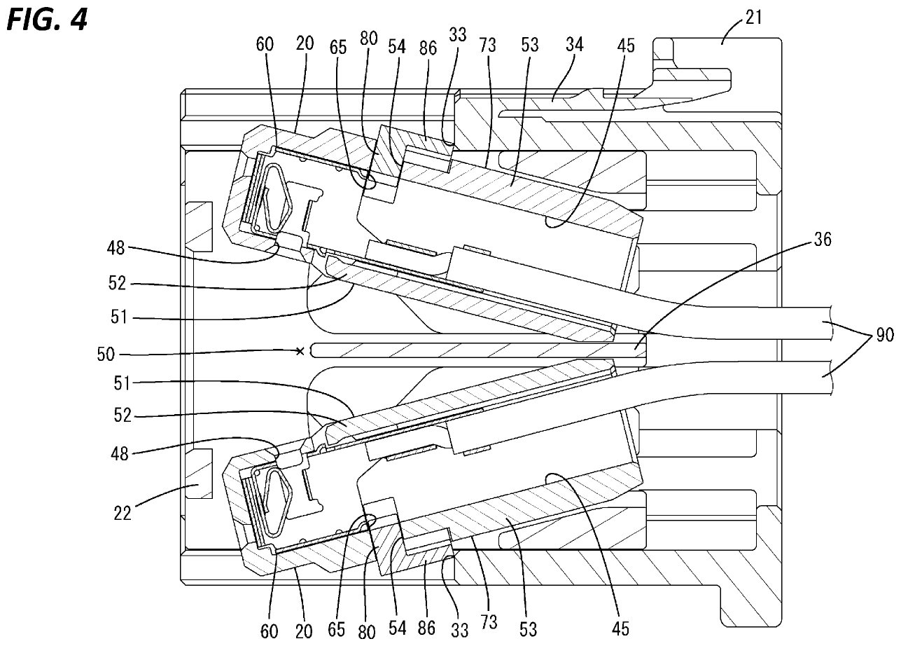

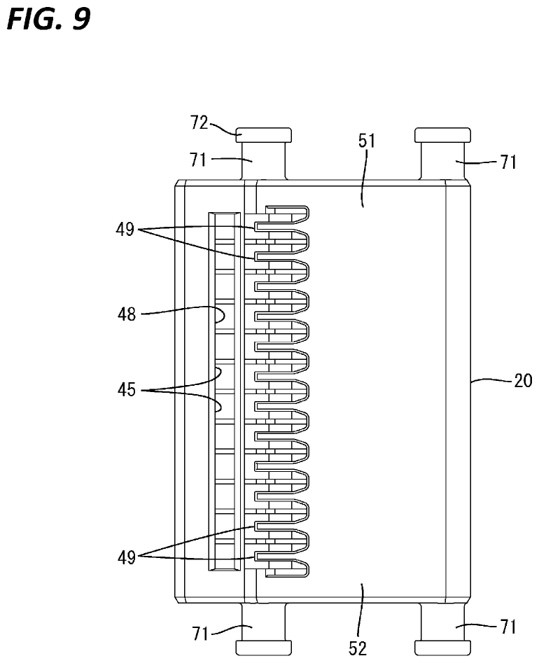

As shown in FIG. 4, the inner housing 20 includes a connection port 48 in an inner wall 52 facing the base portions 61 of the terminal fittings 60 inserted into the respective cavities 45. As shown in FIG. 9, the connection port 48 is a slit-like hole long in the width direction, penetrates through the inner wall 52 and communicates with the respective cavities 45. The connecting members 122 of the circuit board 120 are inserted into the connection port 48. The connecting member 122 enters the terminal body 62 through the hole of the base portion 61 from the connection port 48 and contacts the contact point portion 66 of the resilient contact piece 64 in the terminal body 62. As shown in FIG. 3, the inner wall 52 of the inner housing 20 includes a locking hole 49 behind the connection port 48. A projection 67 provided in the base portion 61 by cutting and raising enters the locking hole 49. As shown in FIG. 4, the outer surface of the inner wall 52 on a side opposite to the cavities 45 is constituted as a flat connection surface 51 in which the connection port 48 is open.

The inner housing 20 includes a retainer mounting hole 54 in an outer wall 53 located on a side opposite to the inner wall 52 via the respective cavities 45. The retainer mounting hole 54 is a rectangular hole long in the width direction, penetrates through the outer wall 53 and communicates with the respective cavities 45. The retainer 80 is inserted into the retainer mounting hole 54. As shown in FIG. 3, a rear part of the retainer mounting hole 54 has a stepped support surface 55 capable of supporting a rear part 86 of the retainer 80 at a midway position in a thickness direction of the outer wall 53.

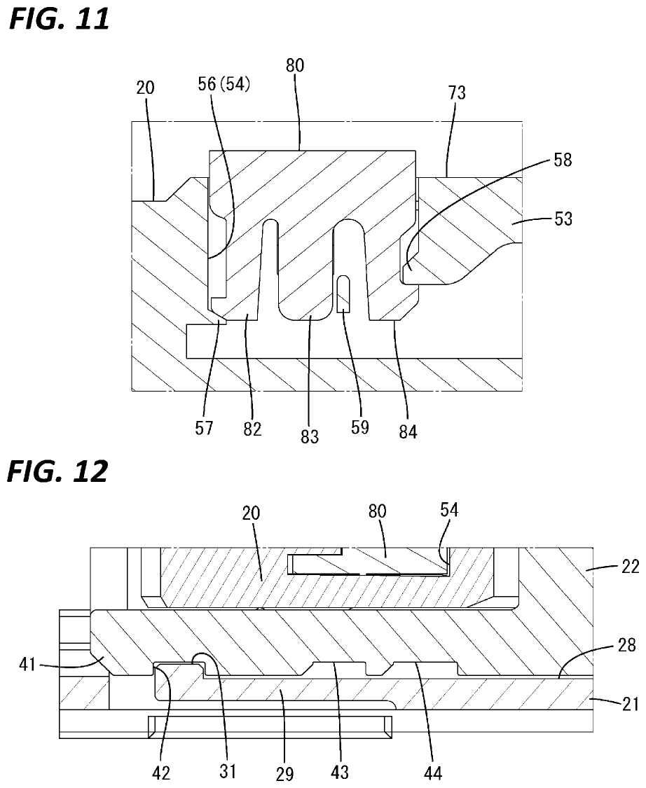

As shown in FIG. 8, retainer locking holes 56 are provided in both left and right end parts of the retainer mounting hole 54. The retainer locking hole 56 has a slit-like region extending forward. As shown in FIG. 11, the inner housing 20 is provided with claw-like full locking portions 57 projecting on the front ends of the retainer locking holes 56 and a claw-like partial locking portion 58 on the rear end of the retainer mounting hole 54. The partial locking portion 58 is larger than the full locking portions 57 and located more outward (upper side of FIG. 11) than the full locking portions 57. Further, the inner housing 20 is provided with a guide rib 59 extending in the vertical direction at a midway position in the front-rear direction of the retainer mounting hole 54. The outer surface of the outer wall 53 on a side opposite to the cavities 45 is constituted as one flat surface 73. As shown in FIG. 3, the one surface 73 of the outer wall 53 is arranged to proximately face the interfering portion 33 of the outer housing 21 when the inner housing 20 is in the second posture to be described later.

As shown in FIG. 9, a pair of front and rear guide pins 71 are provided on each of both left and right surfaces of the inner housing 20. The respective guide pins 71 have a cylindrical shape and project at an interval in the front-rear direction on both left and right surfaces of the inner housing 20. A flange portion 72 protruding over an entire circumference is provided on a tip part of each guide pin 71.

(Retainer)

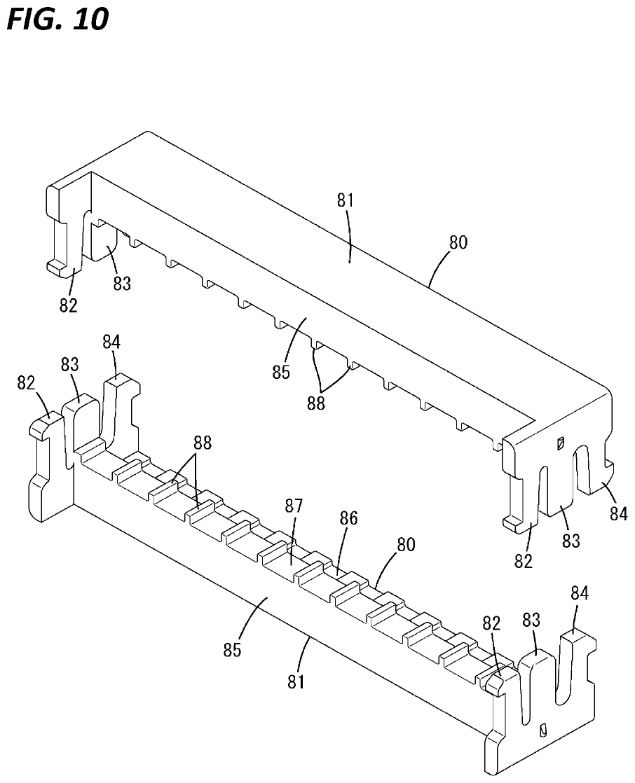

The retainer 80 is made of synthetic resin and includes, as shown in FIG. 10, a body portion 81 extending long in the width direction and locking portions 82, 83 and 84 connected to both left and right ends of the body portion 81. The material constituting the retainers 80 is a material different from that constituting the inner housings 20 and the circuit board 120 and having a thermal expansion coefficient distant from the thermal expansion coefficient (linear expansion coefficient) of the material constituting the circuit board 120. A difference in thermal expansion coefficient between the materials of the retainer 80 and the circuit board 120 is set larger than that between the materials of the inner housings 20 and the circuit board 120. In the case of this embodiment, the material constituting the retainers 80 contains the PBT resin as the base material. Glass fiber and other additives may be added to the PBP resin as the base material in the material constituting the retainers 80.

The retainer 80 is sized to be fit into the retainer mounting hole 54. The retainer 80 is held movably with respect to the inner housing 20 to a partial locking position (see FIG. 4) where the retainer 80 is shallowly inserted in the retainer mounting hole 54 and a full locking position (see FIGS. 3 and 5) where the retainer 80 is inserted deeper into the retainer mounting hole 54 than in a state at the partial locking position.

The front surface of the body portion 81 is a vertical surface along the vertical direction and width direction and constituted as the retaining portion 85. As shown in FIG. 5, the retaining portion 85 faces the retained portions 65 of the terminal fittings 60 inserted into the respective cavities 45 and collectively locks the respective terminal fittings 60 at the full locking position.

As shown in FIG. 10, the rear part 86 of the body portion 81 is arranged to be slightly lower than a front part 87 via a step. The rear part 86 of the body portion 81 is supported on the support surface 55 of the retainer mounting hole 54 at the full locking position. A plurality of ribs 88 extending in the front-rear direction are provided side by side at positions corresponding to separation wall parts partitioning between adjacent ones of the respective cavities 45 in the inner housing 20 on the inner surface (surface facing the terminal fittings 60 with the retainer 80 mounted in the inner housing 20) of the front part 87 of the body portion 81. The outer surface (surface facing outward of the inner housing 20 with the retainer 80 mounted in the inner housing 20) of the body portion 81 is a flat horizontal surface extending in the front-rear direction and lateral direction.

As shown in FIG. 11, the locking portion 82, 83 and 84 is inserted into the retainer locking hole 56. The locking portion 82, 83 and 84 includes a full locking arm 82, a guide piece 83 and a partial locking arm 84 arranged side by side in the front-rear direction.

As shown in FIG. 10, the guide pieces 83 are in the form of strips connected to left and right end parts of the front part 87 and projecting further inward (toward a side where the terminal fittings 60 are located with the retainer 80 mounted in the inner housing 20) than the body portion 81. The full locking arm 82 is in the form of an arm projecting inward from a base end part connected to a front side of the guide piece 83. The full locking arm 82 is deflectable and deformable in the front-rear direction with the base end part as a fulcrum. A claw-like part projecting forward is provided on a tip part of the full locking arm 82. The partial locking arms 84 are in the form of arms connected to left and right end parts of the rear part 86 and projecting further inward than the body portion 81. The partial locking arm 84 is deflectable and deformable in the front-rear direction with a base end part connected to the body portion 81 as a fulcrum. A claw-like part projecting rearward is provided on a tip part of the partial locking arm 84. The partial locking arm 84 is configured to have a larger width in the front-rear direction than the full locking arm 82.

(Assembling Method, Connection Method and Connection Structure of Connector)

First, the pair of upper and lower inner housings 20 are inserted into the housing accommodation space 26 of the outer housing 21 from behind. At this time, the respective front and rear guide pins 71 are inserted into the corresponding guide grooves 27. The front guide pins 71 are arranged in the proximate regions of the guide grooves 27 by way of the separating regions and the top regions from the straight regions. The rear guide pins 71 are arranged in the straight regions of the guide grooves 27. When the front guide pins 71 ride over the top regions of the guide grooves 27, the inner housings 20 are displaced from the second posture, which is the inclined posture, to the first posture, which is the horizontal posture. The front guide pins 71 stay on slopes of the proximate regions of the guide grooves 27, thereby restricting the inner housings 20 from coming out rearward.

Subsequently, the guide member 22 is inserted into the outer housing 21 from front. The inserting portions 41 slide on the groove surfaces of the insertion grooves 28, whereby an inserting operation of the guide member 22 is guided. Further, the guide pins 71 are inserted into the guiding grooves 37. The locking projections 31 slide on the inserting portions 41, whereby the resilient locking portions 29 are deflected and deformed. When the guide member 22 reaches the movement restricting position in the process of inserting the guide member 22, the locking projections 31 are fit into the restricting lock receiving portions 44 and the resilient locking portions 29 resiliently return. As the resilient locking portions 29 resiliently return, the rear guide pins 71 interfere with the holding projections 39 and the resilient arm portions 38 are deflected and deformed. When the guide member 22 reaches the assembled position, the resilient arm portions 38 resiliently return and the holding projections 39 move to behind the rear guide pins 71. At this time, the front guide pins 71 are located in contact with the front ends of the guiding grooves 37. Thus, the guide member 22 is assembled at the assembled position with movements in the front-rear direction with respect to the inner housings 20 restricted. When the guide member 22 reaches the assembled position, the locking projections 31 of the resilient locking portions 29 are fit into the assembling lock receiving portions 43 and the guide member 22 is held at the assembled position with respect to the outer housing 21.

When the guide member 22 is at the assembled position, the pair of upper and lower inner housings 20 are in the horizontal first posture to form a board accommodating portion 50 between the connection surfaces 51 thereof (see FIG. 2). The board accommodating portion 50 has a vertical opening dimension equivalent to a plate thickness of the circuit board 120 in the first posture. Subsequently, the retainers 80 are inserted into the retainer mounting holes 54 through the openings 32 and the window portions 35 from above and below the outer housing 21.

When the retainer 80 reaches the full locking position, the claw-like parts of the partial locking arms 84 are arranged in contact with the partial locking portion 58 from inside to restrict the retainer 80 from coming out from the retainer mounting hole 54 as shown in FIG. 11. Further, when the retainer 80 reaches the partial locking position, the claw-like parts of the full locking arms 82 are arranged in contact with the full locking portions 57 from outside to restrict a movement of the retainer 80 to the full locking position. A moving operation of the retainer 80 is guided by the guide rib 59 arranged along the guide pieces 83.

With the retainer 80 located at the full locking position, the body portion 81 is retracted from the respective cavities 45 without entering the respective cavities 45 except the respective ribs 88. Specifically, an outer part of the body portion 81 is located to project outward from the one surface 73 of the outer wall 53. Particularly, the rear part 86 of the body portion 81 is separated from the support surface 55 and entirely arranged outside the one surface 73 of the outer wall 53 (see FIG. 4).

As described above, when the inner housings 20 are in the first posture and the retainers 80 are at the partial locking position, the terminal fitting 60 is inserted into each cavity 45 from behind. Here, the terminal fitting 60 is smoothly inserted into the cavity 45 without receiving any insertion resistance from a locking lance since the locking lance does not project into the cavity 45. When the terminal fitting 60 is properly inserted into the cavity 45, a front wall part of the terminal body 62 abuts on the front wall 46 of the inner housing 20, whereby the inserting operation of the terminal fitting 60 is restricted. Further, the projection 67 enters the locking hole 49 and is hooked to the rear end of the locking hole 49, whereby the terminal fitting 60 is restricted from coming out from the cavity 45. With the terminal fitting 60 properly inserted in the cavity 45, the contact point portion 66 of the resilient contact piece 64 is arranged to face the hole of the base portion 61 and the connection port 48 of the inner housing 20 from outside.

In the above state, the retainer 80 is pushed to the full locking position with respect to the inner housing 20. When the retainer 80 reaches the full locking position, the claw-like parts of the full locking arms 82 are arranged in contact with the full locking portions 57 from inside to restrict a return movement of the retainer 80 to the partial locking position. Further, when the retainer 80 reaches the full locking position, the rear part 86 of the body portion 81 abuts on the support surface 55 to restrict an inward movement of the retainer 80.

With the retainer 80 located at the full locking position, the retaining portion 85 is arranged in contact with the retained portion 65 of the terminal body 62 along the vertical direction. In this way, the terminal fitting 60 is reliably restricted from coming out from the cavity 45.

Further, with the retainer 80 located at the full locking position, the entire retainer 80 is inserted in the retainer mounting hole 54. At this time, the outer surface of the body portion 81 is arranged to be continuous and flush with the one surface 73 of the inner housing 20 or retracted inwardly from the one surface 73 of the inner housing 20.

Subsequently, the inner housing 20 is displaced from the first posture to the second posture. For example, the inner housing 20 can be displaced to the second posture by pressing the flange portions 72 of the rear guide pins 71 rearward. If a pressing force to the second posture is applied to the inner housing 20, the locking projections 31 of the guide member 22 come out from the assembling lock receiving portions 43 and the resilient locking portions 29 are deflected and deformed since the inner housing 20 and the guide member 22 are integrated. As the inner housing 20 reaches the second posture, the resilient locking portions 29 resiliently return and the locking projections 31 are fit into the standby lock receiving portions 42 (see FIG. 12). In this way, the guide member 22 is held at the standby position in the outer housing 21. Simultaneously, the inner housing 20 is held in the second posture in the outer housing 21 via the guide member 22.

When the guide member 22 is at the standby position, the front guide pins 71 are located in the top regions of the guide grooves 27 and the rear guide pins 71 are located in rear end parts of the straight regions of the guide grooves 27.

The pair of upper and lower inner housings 20 are arranged to be mutually open forward in the second posture. At this time, the board accommodating portion 50 formed between the connection surfaces 51 of the respective inner housings 20 expands the vertical opening dimension toward the front (see FIG. 3). The inner housing 20 does not project outward from the opening 32 and is maintained in a state arranged inside the outer housing 21 also in the second posture. The connection surface 51 of the inner housing 20 is arranged to face an inner front side in the second posture. The one surface 73 of the inner housing 20 is arranged closer to the interfering portion 33 in the second posture than in the first posture. The connector 10 is shipped to a site, where a connecting operation to the mating connector 100 is performed, with the inner housings 20 held in the second posture.

Here, if the retainer 80 is at a midway position between the partial locking position and the full locking position or left at the partial locking position without reaching the full locking position (these cases are referred to as a half-inserted state), the outer part of the body portion 81 projects outward from the one surface 73 of the inner housing 20. Thus, the one surface 73 of the inner housing 20 approaches the interfering portion 33, whereby the outer part of the body portion 81 interferes with the interfering portion 33 to restrict the inner housing 20 from reaching the second posture (see FIG. 4), in the process of displacing the inner housing 20 to the second posture. In this case, since the guide member 22 also does not reach the standby position and the resilient locking portions 29 and the standby lock receiving portions 42 are not locked, the inclined posture of the inner housing 20 cannot be maintained with the outer part of the body portion 81 interfering with the interfering portion 33. Accordingly, the front guide pins 71 are displaced along the inclination of the proximate regions of the guide grooves 27 and the inner housing 20 tries to return to the first posture, which is the horizontal posture. As a result, it can be reliably known that the inner housing 20 has not reached the second posture yet, and it can be detected that the retainer 80 is in the half-inserted state before the shipment to the site where the both connectors 10, 100 are connected.

As described above, in connecting the both connectors 10, 100, it is ensured that the inner housings 20 are held in the second posture with respect to the outer housing 21 and the retainers 80 are at the full locking position.

If the connector 10 is shallowly fit into the receptacle 110 when the connection of the both connectors 10, 100 is started, the circuit board 120 is inserted into the board accommodating portion 50. Then, an end surface of the circuit board 120 abuts on the tip of the partition wall 36 of the guide member 22 to apply a rearward pushing force to the guide member 22. Then, the locking projections 31 come out from the standby lock receiving portions 42 and the resilient locking portions 29 are deflected and deformed.

When the connecting operation of the both connectors 10, 100 proceeds, the circuit board 120 pushes the guide member 22 and the guide member 22 moves rearward together with the inner housings 20 with respect to the outer housing 21. During this time, the front guide pins 71 are displaced forward along the proximate regions of the guide grooves 27 to gradually reduce angles of inclination of the inner housings 20. Further, the locking projections 31 are displaced further forward than the inserting portions 41 and the resilient locking portions 29 resiliently return.

When the both connectors 10, 100 are properly connected, the inner housings 20 are in the first posture, which is the horizontal posture, and the front and rear guide pins 71 move to the straight regions of the guide grooves 27. In the process of reaching the first posture from the second posture, the inner housings 20 gradually approach the plate surfaces of the circuit board 120 and the connecting members 122 of the circuit board 120 enter the terminal bodies 62 through the holes of the base portions 61 and the connection ports 48 of the inner housings 20.

When the inner housing 20 reaches the first posture, the connecting members 122 contact the contact point portions 66 while deflecting the resilient contact pieces 64. In this way, the terminal fittings 60 are connected to the electrically conductive portions 121 of the circuit board 120. Since the resilient contact pieces 64 do not contact corner parts of the end surface of the circuit board 120, the resilient contact pieces 64 are not damaged due to interference with the corner parts of the end surface of the circuit board 120. Thus, a connected state of the terminal fittings 60 and the circuit board 120 can be satisfactorily realized. Further, when the terminal fittings 60 and the circuit board 120 are connected, the projection-like part of the lock arm 34 is fit into the lock receiver 111 of the receptacle 110 and the both connectors 10, 100 are held in the connected state.

With the both connectors 10, 110 properly connected, the circuit board 120 is tightly arranged in the board accommodating portion 50 between the connection surfaces 51 of the pair of upper and lower inner housings 20. Here, the inner housings 20 and the circuit board 120 are made of the same material and there is no difference in linear expansion coefficient. This can prevent relative positions of the inner housings 20 and the circuit board 120 from being shifted. If the inner housings 20 and the circuit board 120 should be made of different materials, the relative positions of the inner housings 20 and the circuit board 120 are not largely shifted if a difference in thermal expansion coefficient between the inner housings 20 and the circuit board 120 is smaller than a difference in thermal expansion coefficient between retainers 80 and the circuit board 120. Thus, the terminal fittings 60 mounted into the inner housings 20 can also be maintained at fixed relative positions to the circuit board 120 and a situation can be prevented in which the contact point portions 66 of the terminal fittings 60 slide on the connecting members 122 to increase connection resistance. On the other hand, the retainers 80 are made of PTB resin or the like unlike the inner housings 20. Thus, the retainers 80 are excellent in toughness and a state where the retaining portion 85 locks the retained portions 65 of the terminal bodies 62 can be satisfactorily maintained.

As described above, according to this embodiment, the inner housings 20 and the circuit board 120 can be prevented from being shifted in position due to a thermal expansion difference since the difference in thermal expansion coefficient between the inner housings 20 and the circuit board 120 is smaller than the difference in thermal expansion coefficient between retainers 80 and the circuit board 120. As a result, an increase of the connection resistance between the circuit board 120 and the terminal fittings 60 can be prevented. On the other hand, since the material of the retainers 80 is not limited to that of the circuit board 120, a degree of freedom in designing the retainers 80 can be enhanced. As a result, the cost of the entire connector 10 can be reduced and the mechanical strength thereof can be improved.

Particularly, since the retainers 80 are made of the material containing the PBT resin tougher than the inner housings 20 as the base material, a concern for breakage when the terminal fittings 60 are locked can be reduced.

Further, according to this embodiment, the one surface 73 of the inner housing 20 can approach the interfering portion 33 and the retainer 80 in the half-inserted state can interfere with the interfering portion 33 in the process of displacing the inner housing 20 from the first posture to the second posture. Thus, the inner housing 20 is restricted from reaching the second posture and it can be detected that the retainer 80 is in the half-inserted state. Therefore, whether or not the retainers 80 are properly inserted can be detected before the shipment to the site where the both connectors 10, 100 are connected.

Further, since an operation of detecting the half-inserted state of the retainer 80 is linked to an operation of connecting the terminal fittings 60 to the surface of the circuit board 120 in the case of this embodiment, it is not necessary to individually perform each operation and a workload can be reduced.

Moreover, since the retainer 80 in the half-inserted state can interfere with the interfering portion 33 in the process of displacing the inner housing 20 from the first posture, which is the horizontal posture, to the second posture, which is the inclined posture, the interfering portion 33 needs not be shaped to project toward the inner housing 20 and can have a simple shape.

### Other Embodiments of Present Disclosure

The embodiment disclosed this time should be considered illustrative in all aspects, rather than restrictive.

Although the retainer has no part projecting from the one surface of the inner housing at the full locking position in the case of the above embodiment, the retainer may have a part projecting from the one surface of the inner housing at the full locking position as another embodiment. A projection amount of the retainer from the one surface at the full locking position is set smaller than that of the retainer from the one surface at the partial locking position. In short, the retainer at the full locking position may not interfere with the interfering portion when the inner housing is in the second posture.

Although a part of the body portion projects from the one surface of the inner housing when the retainer is at the partial locking position in the case of the above embodiment, the entire body portion may project from the one surface of the inner housing when the retainer is at the partial locking position as another embodiment.

Although the pair of upper and lower inner housings are provided with respect to the outer housing in the case of the above embodiment, only one inner housing may be provided with respect to the outer housing as another embodiment.

### LIST OF REFERENCE NUMERALS

10 . . . connector
20 . . . inner housing
21 . . . outer housing
22 . . . guide member
23 . . . side wall
24 . . . upper wall
25 . . . lower wall
26 . . . housing accommodation space
27 . . . guide groove
28 . . . insertion groove
29 . . . resilient locking portion
31 . . . locking projection
32 . . . opening
33 . . . interfering portion
34 . . . lock arm
35 . . . window portion
36 . . . partition wall
37 . . . guiding groove
38 . . . resilient arm portion
39 . . . holding projection
41 . . . inserting portion
42 . . . standby lock receiving portion
43 . . . assembling lock receiving portion
44 . . . restricting lock receiving portion
45 . . . cavity
46 . . . front wall
47 . . . inspection window
48 . . . connection port
49 . . . locking hole
50 . . . board accommodating portion
51 . . . connection surface
52 . . . inner wall
53 . . . outer wall
54 . . . retainer mounting hole
55 . . . support surface
56 . . . retainer locking hole
57 . . . full locking portion
58 . . . partial locking portion
59 . . . guide rib
60 . . . terminal fitting
61 . . . base portion
62 . . . terminal body
63 . . . barrel portion
64 . . . resilient contact piece
65 . . . retained portion
66 . . . contact point portion
67 . . . projection
71 . . . guide pin
72 . . . flange portion
73 . . . one surface
80 . . . retainer
81 . . . body portion
82 . . . full locking arm (locking portion)
83 . . . guide piece (locking portion)
84 . . . partial locking arm (locking portion)
85 . . . retaining portion
86 . . . rear part
87 . . . front part
88 . . . rib
90 . . . wire
100 . . . mating connector
110 . . . receptacle
111 . . . lock receiver
120 . . . circuit board
121 . . . electrically conductive portion
122 . . . connecting member

1. A connector, comprising:
an outer housing;
an inner housing to be arranged inside the outer housing;
a retainer mounting hole open in one surface of the inner housing;
a terminal fitting to be accommodated into the inner housing; and
a retainer to be inserted into the retainer mounting hole, the retainer having a part configured to lock the terminal fitting in a properly inserted state and project outward from the one surface of the inner housing in a half-inserted state,
wherein:
the outer housing includes an interfering portion capable of interfering with the retainer in the half-inserted state, and
the inner housing is held displaceably to a first posture where the one surface is located away from the interfering portion and a second posture where the one surface is located closer to the interfering portion than in the first posture with respect to the outer housing.

2. The connector of claim 1, wherein:
the terminal fitting is connected to a circuit board,
the inner housing has a connection surface and a connection port for connection of the terminal fitting and the circuit board is open in the connection surface, and
the connection surface is arranged to face away from a surface of the circuit board in the second posture and arranged closer to the surface of the circuit board in the first posture than in the second posture with the circuit board accommodated in the outer housing.

3. The connector of claim 2, wherein:
the connection surface is arranged obliquely with respect to the surface of the circuit board in the second posture and arranged along the surface of the circuit board in the first posture, and
the inner housing is in an inclined posture corresponding to the connection surface with respect to the outer housing and the one surface on a side opposite to the connection surface is located on an outer side of inclination in the second posture.
